(19) United States
(12) Patent Application Publication
(10) Pub. No.: US 2007/0024628 A1
(43) Pub. Date: Feb. 1, 2007

(54) Data network connection device for a display and method for processing data downloaded from a data network

(76) Inventors: Joachim Kleine, Augsburg (DE); Frank Wurzel, Augsburg (DE)

Correspondence Address: EDELL, SHAPIRO & FINNAN, LLC, 1901 RESEARCH BLVD., SUITE 400, ROCKVILLE, MD, 20850, US

(21) Appl. No.: 11/493,932

(22) Filed: Jul. 27, 2006

Related U.S. Application Data
(63) Continuation of application No. PCT/DE05/00293, filed on Feb. 21, 2005.

(30) Foreign Application Priority Data
Feb. 19, 2004 (DE) 10 2004 008 248.0

(51) Int. Cl. G06T 1/00

(52) U.S. Cl. 345/501

(57) ABSTRACT

A data-network connection device connects to a display device that displays downloaded data from a data network. The data is downloaded into a memory, and a display unit converts the downloaded data into an output signal for driving the display device. The display unit has an image generation device for generating a graphics image of the data to be displayed irrespective of the resolution of a connected display device, and for saving the graphics image in a graphics memory, and has an output device for outputting a segment of the graphics image from the graphics memory. The output device includes a selector for selecting the segment to be output.

### CROSS REFERENCE TO RELATED APPLICATIONS

This application is a continuation of PCT/DE2005/000293, filed Feb. 21, 2005, and titled “Data Network Connection Device and Method for a Display Device Which is Used to Prepare Data Loaded from A Data Network,” which claims priority to German Application No. DE 10 2004 008 248.0, filed on Feb. 19, 2004, and titled “Data Network Connection Device and Method for a Display Device Which is Used to Prepare Data Loaded from A Data Network,” the entire contents of which are hereby incorporated by reference.

### FIELD OF THE INVENTION

The invention relates to a data network connection device for a display device, having an interface device that comprises an input and is used for establishing a communications link to a data network, an output for connecting a display device, a downloading device for downloading data, to be displayed, from the data network into a memory, and a display unit for converting the downloaded data into an output signal for driving the display device. In addition, the invention relates to a method that can be used in such a data network connection device for processing the data to be displayed.

### BACKGROUND

Data network connection devices are used, for example, to allow a television set to be used not only for receiving television channels, but also for displaying data from a data network, e.g., the Internet. The task managed by the data network connection devices involves not only establishing a communications link to the data network and obtaining required data from the data network, but also processing the data received from the data network so that it can be displayed on the television set in a suitable way.

This in itself involves a major problem, because the resolution of a television set, typically having 720 ×576 pixels, is not suitable for displaying typical HTML pages from the Internet, for example, because these are generally designed for computer monitors and have a width of at least 800 pixels. The height of the page is usually far greater than the displayable 576 pixels of a television set. This stems from the fact that the HTML Pages are developed for displaying on computer monitors, which have a horizontal resolution usually equal to 800, 1024 or 1280 pixels. The pages can be any size vertically depending on the content, and are often far bigger than the vertical resolution of the screen. In order to be able to display all areas of a page, “scrollbars” are used, which are displayed on the bottom and right-hand edge of the screen. The displayed image segment can be moved by moving the bar. This movement is relatively convenient because the bars can be operated by a mouse pointer. Usually, however, a television set has no mouse available for easy operation of the scroll bars.

It is possible, however, to dispense with the scrollbars and instead get the screen content to scroll when the mouse pointer is moved along one of the screen edges. However, since screen content displayable on a television set is smaller than typical HTML pages, a very large number of scroll operations is necessary. In addition, users frequently inadvertently get close to one of the edges of the screen page, and hence initiates an unintentional scroll operation.

After scrolling the screen content, the screen content to be displayed must be re-computed. Re-computing the screen content, depending on the type of information to be displayed, requires an intensive amount of computation and hence takes a relatively long time. Therefore, the user must wait, every time the screen content is re-computed and re-constructed. In addition, the picture appears jumpy during scrolling, which most viewers find very annoying.

### SUMMARY

The invention includes a data network connection device for a display device and a suitable method, with which displaying data from a data network is improved, i.e., can be performed with far less computing time in particular.

According to the invention, a data-network connection device is characterized in that the display unit has an image generation device for generating a graphics image of the data to be displayed irrespective of the resolution of a connected display device, and for saving the graphics image in a graphics memory, and has an output device for outputting a segment of the graphics image from the graphics memory, the output device comprising a selector for selecting the segment to be output.

The advantage of the data-network connection device according to the invention lies in the fact that the graphics image of the data to be displayed needs to be computed only once, regardless of whether the screen content is scrolled. Scrolling is performed according to the invention by the selection and output of a segment of the graphics image, saved in the graphics memory, of the data to be displayed. The graphics image of the segment to be displayed does not need to be re-computed, but can be retrieved directly from the graphics memory. The image segment to be displayed is thus selected simply by reading and displaying a certain memory area of the graphics memory.

The size of the segment to be output can be preset by a user, where advantageously it is selected to match the resolution of the display device used in conjunction with the data-network connection device.

It is also advantageous that it is possible to display such data that consists both of data that is static within a certain time period and of rapidly changing data such as moving images. In a preferred embodiment, two levels are used in the graphics memory for this purpose, where static data is saved in a first level and the moving images in a second level. Whereas the data in the first level does not need to be changed, the data in the second level varies. When a segment to be displayed is selected, only the first level is involved if the segment lies outside the area in which the moving images are meant to play. Prior to output, the data saved in the first level and in the second level are mixed according to the selected segment.

In an advantageous embodiment of the invention, a section of a selected segment can be displayed in magnified form. This can be done using a hardware-implemented magnifying-glass function, i.e., integrated in a graphics controller.

The method, according to the invention, includes the following: downloading data to be displayed from a data network, generating a graphics image of the data to be displayed and saving it in a graphics memory, selecting a segment to be displayed, and outputting the data, that corresponds to the selected segment, from the graphics memory.

Also according to the inventive method, a graphics image of the data to be displayed is generated first and then the segment to be output is specified. The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The invention is explained in more detail below with reference to exemplary embodiments, where

FIG. 1 shows a block diagram of a first exemplary embodiment of a data-network connection device according to the invention,

FIG. 2 is as FIG. 1, but shows a second exemplary embodiment,

FIG. 3 shows a flow diagram of the method according to the invention in a further embodiment,

FIG. 4 shows a flow diagram from downloading an Internet page to displaying a page segment on a television set, and

FIG. 5 shows a flow diagram from opening an Internet page to displaying on a television set according to the prior art.

### DETAILED DESCRIPTION

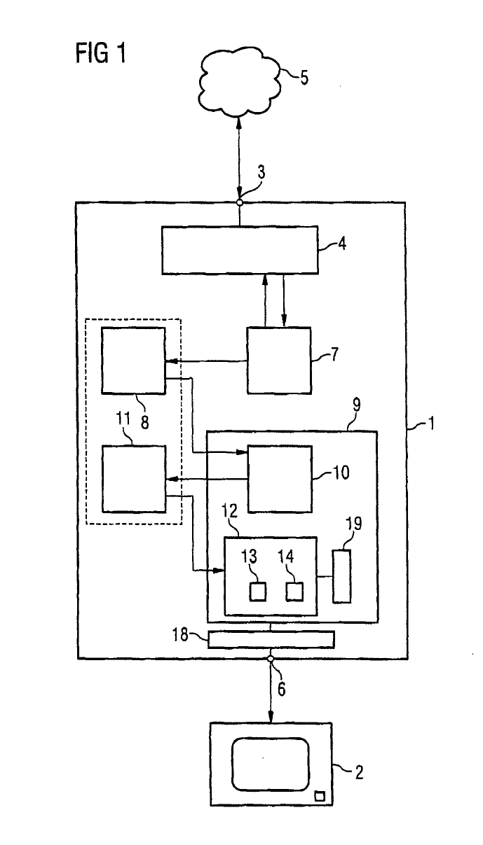

FIG. 1 shows a schematic diagram of a data-network connection device 1 according to the invention, having an input 3 and an output 6. The input 3 of the data-network connection device 1 is connected to a data network, to the Internet 5 in the case illustrated. Inside the device, the input 3 is connected to an interface device 4, which is configured to convert the received digital data so that it can be processed further internally. The interface device is also configured to send data to the Internet 5. The received data is first requested by a downloading device 7, where this is done, e.g., by a user entering a URL or clicking on a link. The downloading device 7 then downloads into a memory 8 the requested data, which is given by, e.g., an HTML page. Once all the necessary data from the page is downloaded, a signal must be generated from the received data that can be used to drive the display device 2 connected to the output 6. A display unit 9 connected to the memory 8 is provided for this purpose. The data from the memory 8 is loaded into an image generation device 10 of the display unit 9. Here, a graphics image of the data to be displayed is computed and then saved in a graphics memory 11.

The image generation device 10 is necessary because the downloaded data in the memory 8 does not exist in a form that can be displayed. An HTML page, for example, contains a large number of commands. A graphics image of the HTML page is first generated from the commands in what is known as a browser, or in the present case in the image generation device 10. This can be done on the basis of user settings, e.g., the font size or the color settings can be controlled.

In addition, the receiver of the HTML-page can integrate graphics elements in the page that are transferred as separate files. Furthermore, add-on programs known as plug-ins or Active-X controls can be run that are configured to display, e.g., animated graphics elements, films or the like. These add-on programs are provided, for example, by program libraries known as DLL files in Microsoft Windows, and do not need to be downloaded from the Internet with the HTML page. Only the data to be processed by the add-on programs needs to be downloaded.

According to the invention, a graphics image is computed from the data of all the data to be displayed. In contrast, Internet browsers, of the prior art, work in such a way that they compute only the graphics image of the part of a page that can be displayed on the display device.

The display device 9 also comprises an output device 12 for outputting a segment of the graphics image saved in the graphics memory 11. The size of the segment can be defined by initial settings of the user, and advantageously equals the resolution of the user's display device. This guarantees that subsequent circuit components need to process only that amount of data that can be displayed, i.e., what is visible to the user. It can also be ensured, for example, during scrolling, that the new screen content follows directly after the old content.

The output device 12 comprises selector 13 for selecting the segment to be output. This enables horizontal and vertical scrolling over the whole page. Explained graphically, the segment to be output corresponds to a window of a preset size that is moved over the graphics image of the whole page saved in the graphics memory and that only ever allows one segment to be seen. According to the invention, the graphics image of the screen content to be displayed does not need to be re-computed when the window is moved, but the data can be retrieved from the graphics memory already in computed form. The data-network connection device 1 comprises an interface 18 for this purpose, which converts the digital signals from the output device 12 into an analog output signal, e.g., for driving a television set. Any analog or digital interfaces are possible at this point, however, so that computer monitors, video beamers or recording equipment can also be connected.

In an advantageous embodiment, the output device 12 comprises zoom device 14 for displaying a section of a selected segment in magnified form. If a page contains poorly legible or identifiable areas, this area can be magnified by the zoom device 14. Such a function can be implemented without increased computational load by the use of hardware-implemented functions of a graphics chip, which themselves select a section of the segment selected by the selector 13, and supply it in magnified form for display.

A segment adjoining the previously displayed segment is selected by moving a cursor along one of the screen edges so as to scroll in this direction, i.e., the window is moved in this direction. The area that is moved can equal the screen height or screen width or a part thereof.

It must be ensured that a user can also make inputs at the same time as selected segments are output, e.g., enter text or in particular click with a cursor on certain areas. The input coordinates must thus be computed in a similar way to the displayed segment of the data to be output. A cursor controller 19 is therefore connected to the output device 12. A cursor controller of this type is well known in the present state of the art and is hence not explained in detail.

In a development of the invention, another function is provided that takes account of a problem specific to displaying Internet pages on a television set. Owing to the poorer resolution of a television set and the often relatively large distance between a user and the screen, in certain cases it is not easily identifiable where the field is in which one wants to make an input, or is an active link that could be enabled by the next press of a button. It is advantageous in this case if the data to be displayed is saved in the graphics memory not just as a pure pixel image, but by parsing the page, individual image elements—link elements for the function just described—can also be identified. It is thereby possible to identify a currently active link or an active input field by a focus frame or other way of highlighting. However, it will be appreciated that the concept of the invention can be applied in other contexts.

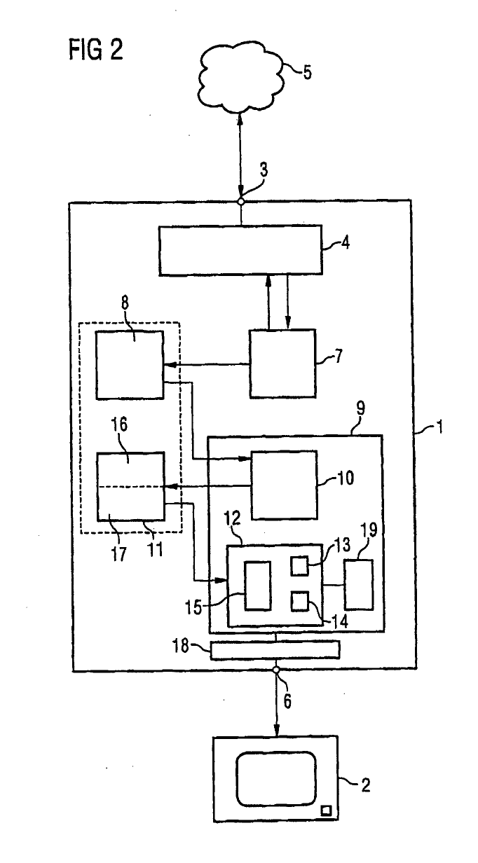

FIG. 2 shows a development of the data network connection device of FIG. 1. In this exemplary embodiment, the graphics memory has two or more levels 16 and 17. The graphics image of all the HTML elements that were generated by the image generation device 10 are saved in the first level 16. Moving images generated by an Active-X control or a plug-in are saved in the second level 17. The advantage lies in the fact that while nothing has changed there, the whole HTML page does not need to be re-computed for every change in the moving image. Although it is necessary to re-compute, after a change to the HTML page, re-computation rarely happens. In the period between two changes in the HTML page, the data is static, to distinguish it from video films or other moving elements that have a far higher refresh rate.

This division of the graphics memory 11 thus makes it possible to retain unchanged the sometimes very large HTML page in the first level 16, and only to continuously update the memory 17, where the moving images usually involve only a very small area of the whole data contained on a page.

For the display, i.e., for the output of an output signal, it is necessary to combine the data saved in the first level 16 and the second level 17 of the graphics memory 11. The output device 12 has a mixing device 15 for this purpose, which generates a common graphics image from the data of the two memory levels.

Depending on how the segment to be output was selected, only data from the first memory level 16 needs to be taken into account by the mixing device. This is the case when no moving images are located in the selected segment. If, however, moving images are also to be shown in the selected segment, the graphics images of the first level 16 and the second level 17 are superimposed in such a way that either the graphics image from the second level 17 is placed in the foreground or is transparent to let the graphics image of the first level 16 be seen.

In this exemplary embodiment two levels are provided; it is also possible, however, to provide more than two levels in the graphics memory 11, each of which contain in a graphics image different components of the data to be displayed.

Further processing of the image, e.g., the zoom function previously described, is carried out as in the exemplary embodiment of FIG. 1, because at the output of the mixing device 15 there is still just one two-dimensional graphics image.

The memory 8 and the graphics memory 11 together with its levels 16 and 17 are shown in the diagram of FIG. 1 as separate components. Of course it is possible to combine these memories in a common memory component. Depending on the hardware available, however, the memories can also be distributed so that the memory 8 is located in a RAM assigned to a processor, and the graphics memory 11 is assigned to a graphics controller forming a separate functional unit.

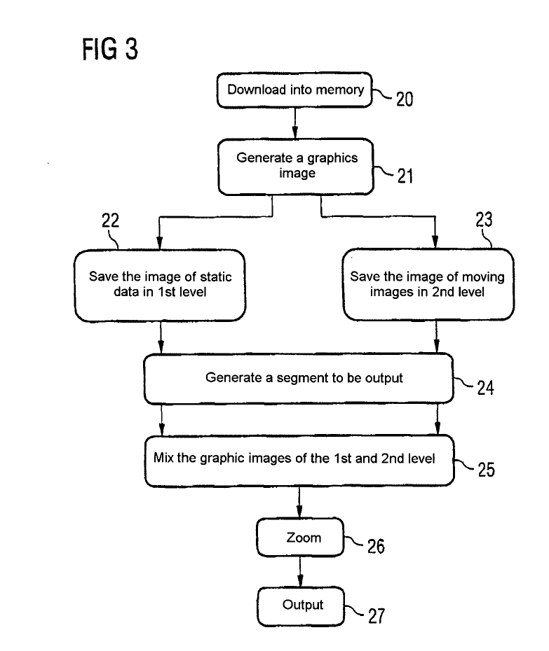

FIG. 3 shows a flow diagram of a method according to the invention that summarizes the method steps being executed.

In a first step 20, data from the Internet is downloaded into a memory. Then in step 21, a graphics image is generated from the downloaded data. This can be done separately for different elements of the data to be displayed, where in the exemplary embodiment shown, the graphics image of static data, i.e., data that only changes relatively rarely, is saved in the first level of a graphics memory (step 22). Step 23 is performed in parallel with this, in which the graphics image of moving images is saved in the second level of the graphics memory.

Then in a step 24, a “window” is placed over the first and second level of the graphics memory. The windows are always moved in parallel, so that the same segment is obtained in both levels. After selecting the segment to be output, the graphics images from the first and second level are mixed in a step 25, so that a two-dimensional graphics image is obtained containing data from both the first level and the second level of the graphics memory.

In a subsequent optional step 26, a section of the selected image segment is shown in magnified form, also called “zooming”. Finally, the mixed data or the mixed and zoomed data corresponding to the graphics image is output, for which the output interface 18 is used.

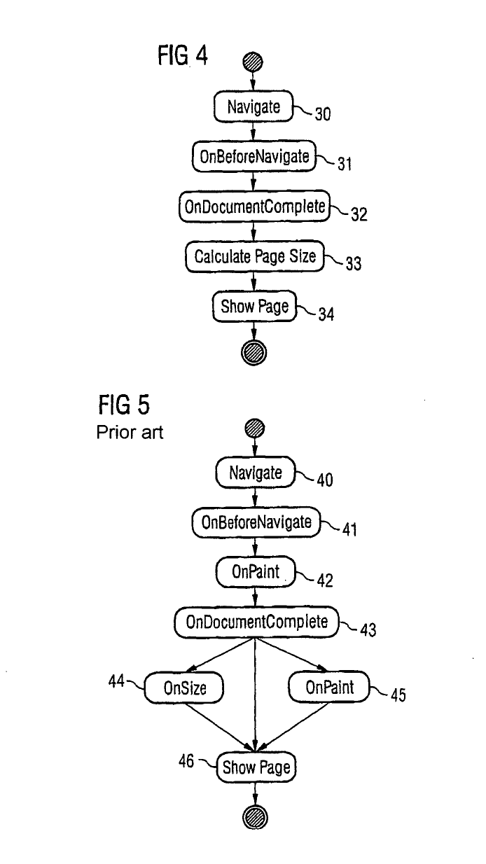

FIGS. 4 and 5 are used to compare how the method according to the invention differs from the method of the prior art. FIG. 5 will be considered first, which explains the method according to the prior art. The method starts with a user entering a URL, i.e., the address of a page to be displayed from the Internet. Then, according to the method described here which uses a standard browser, a check is made as to whether the URL is available. In a step 42, the data just downloaded is displayed, with the display updated at short time intervals in order to provide the freshly downloaded data for display as well.

In a step 43 it is established that the page has finished downloading. Then in steps 44 and 45, a user has the options to change the page size or to move the page in a step 45. Finally in a step 46, the page to be displayed is re-computed and re-output according to user actions in the steps 44 or 45.

FIG. 4 shows for comparison the method according to the invention. As in the known method of FIG. 5, this also starts in a step 30 with the user entering a URL, and in a step 31 a check being made as to whether the URL is available. In a step 32 it is established whether the page has finished downloading. Up to this point, no graphics image of the downloaded data is generated or displayed, so this differs from the method of the prior art, according to which a graphics image is generated and displayed at short time intervals.

Then in a step 33, the page size to be displayed is calculated, which depends on the initial user defined settings. In an intermediate step (not shown), the graphics image of the whole page is computed in advance, as was explained with reference to FIGS. 1 and 2.

After calculating the page size in step 33, the selected segment is output in a step 34, so that the segment can be displayed by a display device.

While the invention has been described in detail and with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

List of Reference Signs

1 data-network connection device
2 display device
3 input
4 input interface
5 data network
6 output
7 downloading device
8 memory
9 display unit
10 image generation device
11 graphics memory
12 output device
13 selector
14 zoom device
15 mixing device
16 first memory level
17 second memory level
18 output interface
20 to 27 method steps
30 to 34 method steps
40 to 46 method steps

What is claimed is:

1. A data network connection device for a display device, comprising:
an interface device that comprises an input for establishing a communications link to a data network;
an output configured to be coupled to the display device;
a memory;
a downloading device for downloading data, to be displayed, from the data network into the memory;
a graphics memory; and
a display processing unit for converting the downloaded data into an output signal for driving the display device, the display processing unit comprising: an image generation device for generating a graphics image based on a page description contained in the data to be displayed, irrespective of the resolution of the display device, and for saving the graphics image in the graphics memory; and an output device for outputting a segment of the graphics image from the graphics memory, the output device comprising a selector for selecting the segment to be output.

2. The data network connection device of claim 1, wherein the output device further comprises a zoom device for displaying a section of the selected segment in magnified form.

3. The data network connection device of claim 2, wherein the output device permits a user to preset a size of the segment to be output.

4. The data network connection device of claim 1, wherein the output device permits a user to preset a size of the segment to be output.

5. The data network connection device of claim 1, wherein the graphics memory comprises a first level that stores a graphics image of static data, and a second level that stores a graphics image of moving images.

6. The data-network connection device of claim 5, wherein the output device further comprises a mixing device that generates a common graphics image from the graphics images of the first and second levels.

7. The data-network connection device of claim 1, wherein the image generation device generates an identifier for active links or input fields contained in the data to be displayed.

8. A method for processing data downloaded from a data network, comprising:
downloading data to be displayed from the data network;
generating a graphics image based on a page description contained in the data to be displayed and saving the graphics image in a graphics memory;
selecting a segment to be displayed, and
outputting, from the graphics memory, the data that corresponds to the selected segment.

9. The method of claim 8, further comprising forming the segment to be displayed to a size that is preset by a user.

10. The method of claim 8, further comprising:
magnifying a section of the selected segment via a user initiated process.
